(19) United States
(12) Patent Application Publication
(10) Pub. No.: US 2004/0034964 A1
(43) Pub. Date: Feb. 26, 2004

(54) Drive for a movable element

(76) Inventors: Jorg Loggen, Windeck (DE); Wolfgang Koppatsch, Augustin (DE)

Correspondence Address: BROUSE McDOWELL, 500 First National Tower, 106 S. Main Street, Akron, OH, 44308-1471, US

(21) Appl. No.: 10/644,180

(22) Filed: Aug. 20, 2003

(30) Foreign Application Priority Data
Aug. 20, 2002 (DE) 102 38 966.7
Sep. 12, 2002 (DE) 102 42 267.2

(51) Int. Cl. E05F 3/00

(52) U.S. Cl. 16/49

(57) ABSTRACT

The invention relates to a drive (1) for a movable element, with which the element is brought from an initial position into a second position, an opening and closing position in particular. The drive (1) has a housing (2), at least one spring element (9) arranged in the housing (2), at least one spring supporting member (6) at which the spring element is supported (9), and at least one roller element (19, 20, 26, 27) arranged at the spring supporting member. The task of the invention is therefore to simplify the design of the known drive in order to facilitate assembly and reduce the manufacturing and assembly costs. According to the invention the spring supporting member (6) of the drive (1) has at least one curved surface (18, 25), and the roller element (19, 20, 26, 27) is arranged at the curved surface (18, 25).

### DESCRIPTION

The invention relates to a drive for a movable element, with which the element is brought from an initial position into a second position, an opening and closing position in particular.

Such a drive is known from DE 42 39 219 C2. This document relates to a door closer with a housing in which a pressure spring is arranged. Furthermore, the known drive has a spring supporting member in the form of a spring support at which the pressure spring is supported. Two rotatably supported rollers are arranged at the spring support, so that they lie in the same plane as a lifting cam and so with a rotation of the lifting cam come consecutively into contact with this depending on the opening angle of the door.

A further drive in the form of a door closer is known from DE 34 11 189 C2. The drive known from this document also has a housing in which a helical compression spring is arranged. This is supported on a spring supporting member in the form of a movable piston. Rollers are also provided which interact with a lifting cam.

Both known drives have a large number of components which complicate the structure of the drive and render the manufacture of the drive expensive.

The object of the invention is therefore to simplify the configuration of the known drive in order to facilitate assembly and reduce the manufacturing and assembly costs.

This object is achieved according to the invention by a drive with the characteristics of claim 1.

The invention provides for a drive for a movable element (a door for example), with which the element is brought from an initial position into a second position, in particular an opening and closing position. The drive according to the invention has a housing as well as at least one spring element arranged in the housing. Furthermore, at least one spring supporting member is provided at which the spring element is supported, and at least one roller element arranged at the spring supporting member. The spring supporting member has at least one curved surface, the roller element being arranged at the curved surface and running on this curved surface.

The drive according to the invention is provided in particular for the purpose of bringing a door, a glass door for example, from a starting position into a further position. For example, it is possible with the drive according to the invention to open and close the door without difficulty.

The invention has the advantage in that a separate lifting cam is no longer necessary. Rather, the curved surface which perceives the function of the lifting cam is itself arranged at the spring supporting member. In so far the structure of the drive according to the invention is simplified. The manufacturing and assembly costs are reduced as a result.

In the case of the drive according to the invention it is preferably provided that the spring supporting member for storing energy in the spring element is arranged so that it is movable along its axis in the direction of the axis of the spring element.

In a further embodiment of the invention it is provided that the spring element is supported at an initial end of the spring supporting member and that at a second end of the spring supporting member the curved surface is arranged. Hence the spring element is arranged at a different end of the spring supporting member as the curved surface.

In a further embodiment of the invention at least one opening is arranged at the spring supporting member, which opening has a curved opening surface. At least two roller elements are preferably provided with this embodiment, one roller element being arranged at the curved surface provided at the second end of the spring supporting member and the other roller element at the curved opening surface of the opening.

The roller element running on the curved surface of the spring supporting member serves to move the spring supporting member in the direction of the spring element, in order to load or tension the spring element from an initial into a second position when the movable element moves. In doing so, energy is stored in the spring element, which energy is used to bring the movable element from the second position into the initial position again.

The roller element, which runs on the curved opening surface of the opening, serves as a damper respectively a brake as regards the sequence of movement. In doing so, a certain force must be applied when a door opens for example, in order to bring the door from an initial position into a second position. Conversely, it can be provided that a certain force must be applied in order to bring the door from a second into the initial position.

Furthermore, it is preferably provided that the spring supporting member in the housing of the drive is movable arranged along an axis of the housing.

In one embodiment of the invention a shaft is received in the housing, at which shaft the spring element is arranged, the shaft having an initial and a second end. The spring can, for example, be arranged so that the shaft projects through the spring (a helical spring for example). The shaft is preferably held in the spring supporting member. In order to guarantee mobility of the spring supporting member in the housing, a bearing, preferably a ball bearing, is arranged between two adjacent surfaces of the shaft and of the spring supporting member.

In a further embodiment the housing has a longitudinal axis and the shaft runs along this longitudinal axis essentially across the full length of the housing. Here, “essentially” means that the shaft can run along the longitudinal axis of the housing across the full length of the housing or across the majority of the length of the housing.

In a further embodiment of the invention the spring element has an initial and a second end, each end respectively arranged at a spring retaining washer. This serves in particular to better support the spring element. The spring retaining washer arranged at the first end of the spring element is preferably also arranged at the spring supporting member.

In a further embodiment of the invention the housing has an initial and a second end. A bearing is preferably respectively arranged at both ends of the housing, the bearing guaranteeing that the drive can rotate around the longitudinal axis of the housing. It is also preferably provided that the spring retaining washer arranged at the second end of the spring element is arranged at the bearing arranged at the first end of the housing.

In order to be able to assemble the various elements inside the housing, the housing preferably has a housing cover at the initial end of the housing. The second end of the housing also preferable has a coupling flange which can be secured to a floor using fastenings in order to be able to secure the drive to a floor.

In addition to or as an alternative to the bearing already mentioned at the spring retaining washer and which is arranged at the second end of the spring element, a bearing can also be arranged at the second end of the housing between a disk and the coupling flange. This in turn serves the improved mobility of the drive.

In a further embodiment a setting ring is arranged at the initial end of the housing. The bearing is preferably arranged between the setting ring and the spring retaining washer of the second end of the spring element. The setting ring preferably has a thread assigned to a thread at the initial end of the housing. It is further preferably provided that the initial end of the shaft assigned to the initial end of the housing has a receptacle with a thread and that a loading disk is arranged between the initial end of the shaft and the housing cover. By means of the setting ring it is possible to pre-load the spring element via the bearing and the spring retaining washer and so to set a certain opening and closing force. This is preferably supported by the loading disk which can be arranged at the shaft by means of a fastening. The loading disk is designed so that it can also act on the bearing. It also serves to center the shaft in the housing.

In a further embodiment of the invention the housing has a roller pin that can receive the roller element arranged at the curved surface of the spring supporting member. It is also preferably provided for a roller pin to be arranged at the opening of the spring supporting member at which roller pin the roller element is arranged which runs at the curved surface of the opening. The shaft may have a receptacle especially for this roller pin.

In order to arrange the movable element at the drive according to the invention, at least one clamp fitting is preferably provided to receive the movable element.

In a further embodiment at least one additional damping element is provided which damps respectively brakes the movement of the element from an initial to a second position.

In a preferred embodiment of the invention a setting system for the movable element is assigned to the drive. Such an embodiment is always advantageous, if the element is a door and the drive is secured to a floor. The door must namely not only be secured to the floor but the upper and lower edge of the door must be arranged in relation to one another so that the drive can operate. For this such a setting system is preferably arranged at the upper edge of the door. The setting system may comprise an eccentric for example. A disk is preferably provided as an eccentric arrangement and at which a ball is arranged whose position can be adjusted using an adjusting element.

In a further embodiment the setting system has a shaft, a connecting link element arranged at the shaft and a guide element arranged at the shaft. The arrangement is such, here, that the guide element is arrangement relatively movably to the connecting link element. In this manner setting the movable element is possible. The connecting link element is preferably connected with the guide element via at least one setting means, a screw in particular, which engages in a thread of the connecting link element. Using the screw (or using several screws) it is possible to move the connecting link element relative to the guide element.

It is also provided that at least one bearing is arranged in the guide element.

The housing, spring supporting member and/or the guide elements are preferably cylindrical in shape. It is also advantageous for the housing, spring supporting member and/or the guide element to be formed as a sleeve.

In the following the invention is described in more detail using an example embodiment and figures:

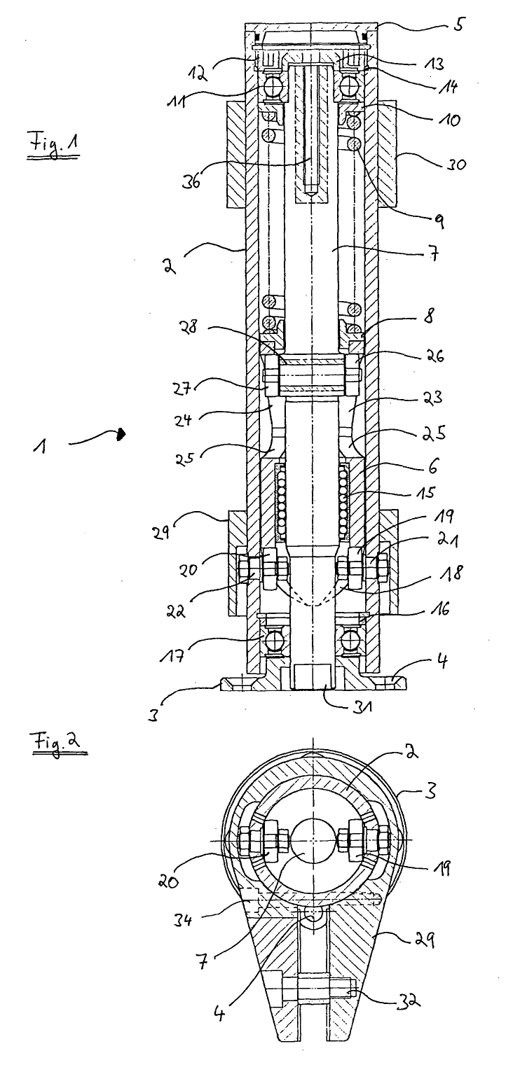

FIG. 1 is a sectional view of the drive;

FIG. 2 is a sectional view of the drive according to FIG. 1;

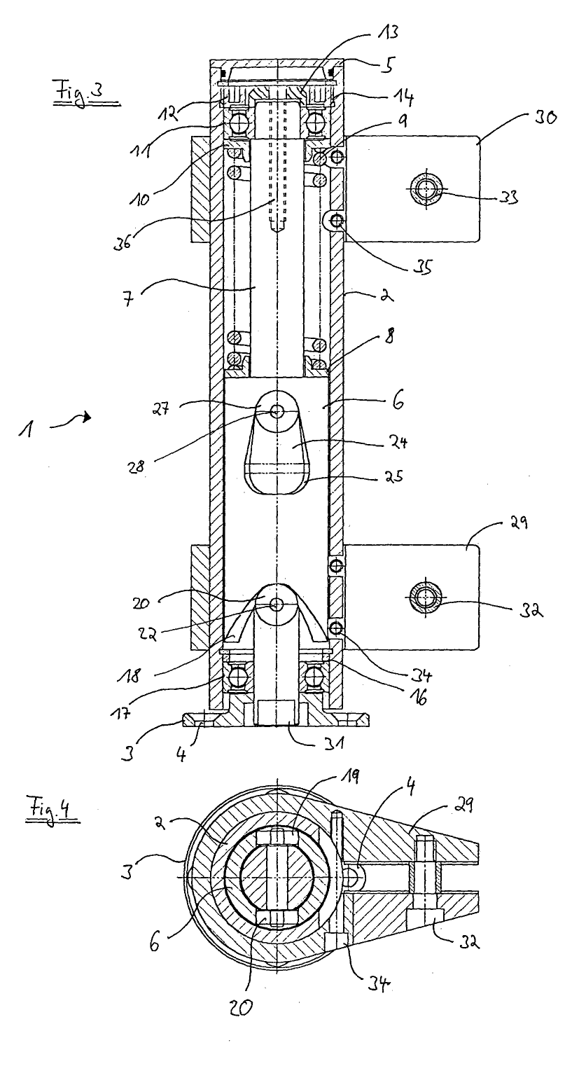

FIG. 3 is a sectional view of the drive according to FIG. 1, the drive being shown rotated 90° round its axis;

FIG. 4 is a sectional view of the drive according to FIG. 3;

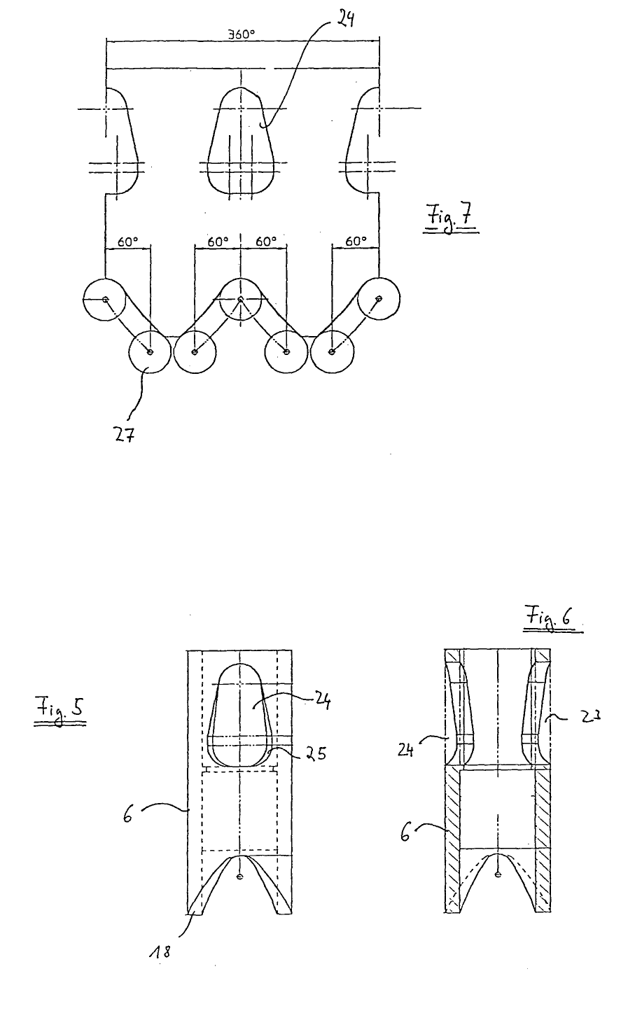

FIG. 5 is a lateral view of a spring supporting member;

FIG. 6 is a sectional view of the spring supporting member according to FIG. 5;

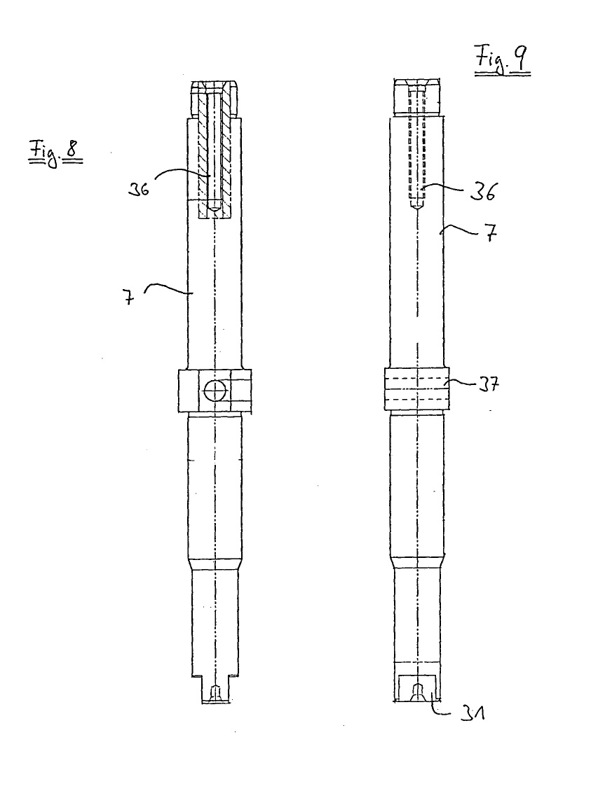

FIG. 7 is a diagrammatic representation of the path of a roller;

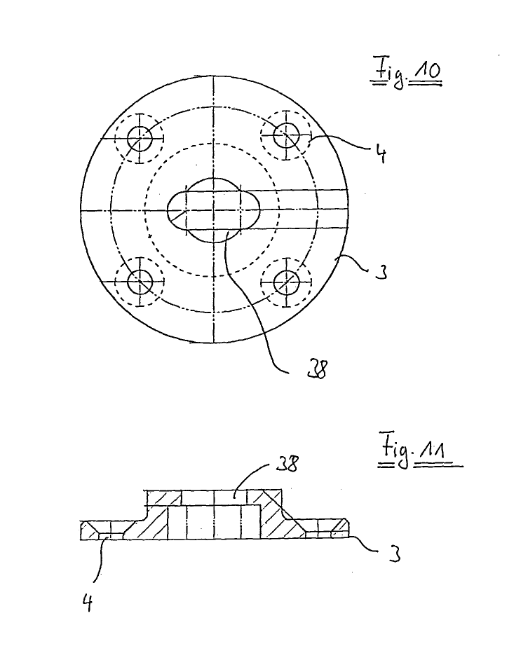

FIGS. 8 and 9 are lateral views of a shaft,

FIG. 10 is a plan view of a coupling flange;

FIG. 11 is a sectional view of the coupling flange according to FIG. 10;

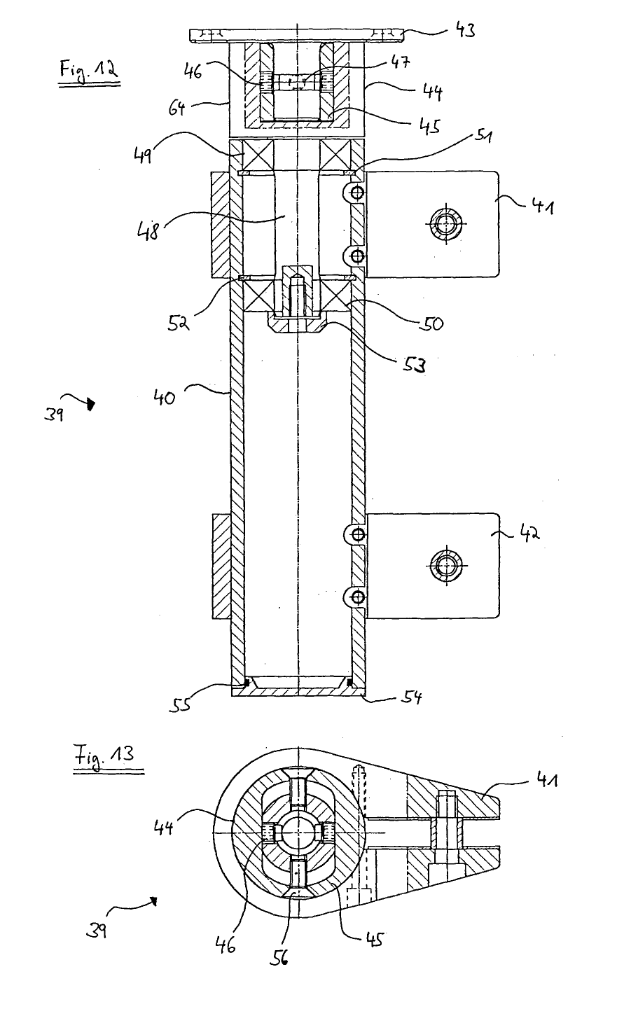

FIG. 12 is a sectional view of a setting system;

FIG. 13 is a further sectional view of the drive according to FIG. 1;

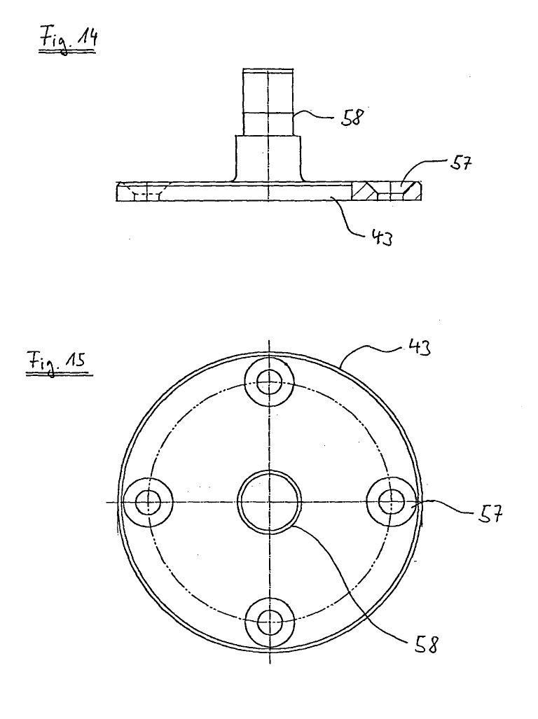

FIGS. 14 and 15 views of a ceiling flange;

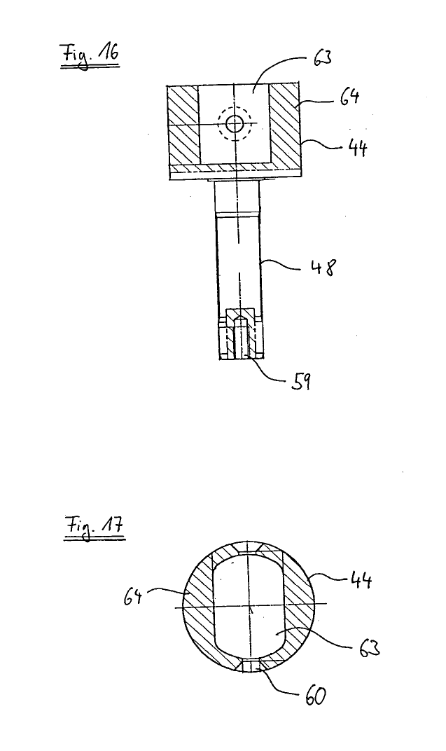

FIGS. 16 and 17 views of a shaft for the setting system;

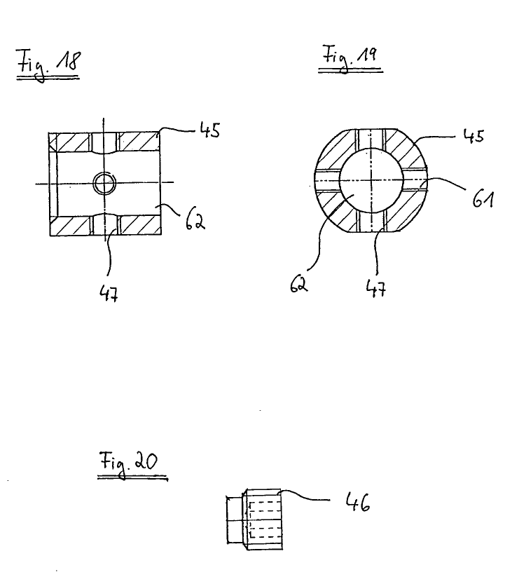

FIGS. 18 and 19 views of a connecting link element for the setting system; and

FIG. 20 is a view of a setscrew for the connecting link element.

The example embodiment described herein relates to a floor-concealed door closer 1 for a glass door. However, express reference is made to the fact that the invention is not restricted to glass doors, rather the drive according to the invention can be used for any movable element.

In the following the structure of the floor-concealed door closer 1 is described. The method of operation of the floor-concealed door closer 1 is then described in more detail.

FIG. 1 is a sectional view of the floor-concealed door closer 1. The floor-concealed door closer 1 has a cylindrical housing 2, at one end of which a coupling flange 3 is arranged, which serves to connect the floor-concealed door closer 1 with a floor. The floor-concealed door closer 1 is secured to the floor via the coupling flange 3 using screws arranged in boreholes 4. FIGS. 10 and 11 show a detailed view of the coupling flange 3. At the other end of the housing 2 a housing cover 5 is arranged which seals the interior of the housing 2 from the external environment.

In the housing 2 a shaft 7 is arranged which extends essentially from one end of the housing 2 to the other end of the housing 2. One end of the shaft 7 is arranged in a fastening 31 of the coupling flange 3 in such a way that the shaft 7 is rigid (in other words, it cannot move). FIGS. 8 and 9 are a detailed view of the shaft 7. Around the shaft 7 a pressure spring 9 is arranged which also has two ends. One of the ends abuts a spring retaining washer 10, which is arranged inside the housing 2 around the shaft 7. On the spring retaining washer 10 a bearing 11 is arranged above which a setting ring 12 is arranged in turn. The setting ring 12 has on its side a thread which can act with a thread 14 on the inner surface of the housing. At the bearing 11 and one end of the shaft 7 a loading washer 13 is arranged, which has a borehole into which a screw can be fitted. This screw can engage in a tapped hole 36 of the shaft 7.

The other end of the pressure spring 9 is arranged at one side of a spring retaining washer 8. At a further side of the spring retaining washer 8 a spring supporting member 6 is arranged. The spring supporting member 6 is (like the housing 2) sleeve-shaped. The shaft 7 is received in the sleeve-shaped spring supporting member 6. To be more exact, the shaft 7 runs fully through the sleeve-shaped spring supporting member 6. In order to permit a movement of the spring supporting member 6 relative to the shaft 7, a ball bearing 15 is let into an interior wall of the spring supporting member 6, which ball bearing in turn abuts the outer surface of the shaft 7.

At the end of the shaft 7 which is let into the coupling flange 3, a further bearing 17 is arranged inside the housing 2 around the shaft 7, one side of this bearing butting the coupling flange 3 and the other side a disk 16.

As can be seen in FIGS. 1, 3, 5 and 6 in particular, the spring supporting member 6 has two ends, two curved surfaces opposing one another 18 being arranged at one end of the spring supporting member 18. In other words, this end of the spring supporting member 6 has two essentially U-shaped recesses which oppose one another. These U-shaped recesses form the curved surfaces 18.

At each of the two opposing curved surfaces 18 a roller 19 respectively 20 is arranged, which is each held at the housing 2 by a roller pin 21, 22. For this, a screw nut is respectively fitted to the one side of the roller pin 21, 22, which screw nut engages in a thread on the respective roller pin 21, 22. The roller 19 respectively 20 is secured using a screw to the other end of the respective roller pins. The roller 19 respectively 20 is arranged here in such a way that it runs on the curved surface 18 of one of the two U-shaped recesses of the spring supporting member 6.

Furthermore, the spring supporting member 6 has two opposing openings 23 and 24, which have respectively a curved opening surface 25. These curved opening surfaces 25 are arranged at the sides which limit the openings 23 and 24. According to FIG. 9 the shaft 7 also has a recess 37, in which a roller pin 28 is fitted (cf. FIGS. 1 and 3). A roller 26 is arranged at the one end of the roller pin 28 and a roller 27 at the other end of the roller pin. The roller 26 runs along the curved opening surface 25 of the roller pin 23, whereas the roller 27 runs on the curved opening surface 25 of the opening 24.

The door (not shown) driven using the floor-concealed door closer 1 is secured using clamps 29 and 30 using clamping joints 32, 33. The clamps 29 and 30 are in turn secured to the housing 2 of the floor-concealed door closer 1 using fastenings 34, 35. The clamp 29 has a cylinder-shaped recess, in the sides of which dents are let in, in order to receive the screw nuts which secure the rollers pins 21 and 22 to the housing 2. FIGS. 2 and 4 are a detailed representation of the clamp 29.

In the following the method of operation of the drive in the form of a floor-concealed door close 1 according to the invention is described.

If the door (not shown) is opened (in other words, moved from a starting position to an opened position), the complete housing 2 rotates in the direction of opening. In doing so, the rollers 19 and 20 run along the curved surfaces 18 of the two U-shaped recesses of the spring supporting member 6. In doing so, the spring supporting member 6 is moved in the direction of the pressure spring 9 in such a way that the pressure spring 9 is loaded. The energy stored in the pressure spring 9 is used after the opening procedure to move the door back automatically into the starting position. In doing so, the pressure spring 9 presses via the spring retaining washer 8 on the spring supporting member 6 in such a way that the spring supporting member 6 is moved in the direction of the coupling flange 3. In doing so, the door (not shown) is again brought into the starting position.

The closing force of the pressure spring 9 can be set using the setting ring 12. In doing so, the setting ring 12 is moved along the axis of the housing 2 due to the thread connection described above in such a way that a loading force is exerted on the pressure spring 9. This is supported using the loading washer 13.

The rollers 26 and 27 in the openings 23 and 24 of the spring supporting member 6 and running on the curved opening surface 25 serve as damping elements in doing so. As the course of the roller movement of roller 27 represented schematically in FIG. 7 shows, the roller must first, from a starting position, overcome a travel corresponding to a rotation of 60°. Along this travel a certain resistance is generated when the door moves due the shape of the curved opening surface 25. This resistance reduces during the course of the further movement up to a maximum rotation of 180°.

In the example embodiment shown of the invention at least on additional damping element can be provided without difficulty, which damps respectively brakes the movement of the element from an initial to a second position.

The invention described has the advantage in that, in contrast to state of the art, a separate lifting cam is no longer necessary. Rather the curved surface, which perceives the function of the lifting cam, is arranged at the spring supporting member 6 itself. In so far the structure of the drive according to the invention is simplified. The manufacturing and assembly costs are reduced as a result.

The door in the example embodiment shown must not only be held on the floor, but the upper and lower edge of the door must also be arranged in relation to one another in such a way that the drive described can operate. To do this, such a setting system 39 is arranged in the region of the upper edge of the door.

FIGS. 12 and 13 show the setting system 39, which is secured in the upper region of the door with clamps 41 and 42. In addition, the setting system 39 is secured to a ceiling (not shown) via a ceiling flange 43. FIGS. 14 and 15 show a detailed representation of the ceiling flange 43. This has openings 57 arranged at 90°, in which the screws are received which can be fitted in the ceiling. Furthermore, the ceiling flange 43 has a projection 58 which projects into an opening of a shaft 44.

The shaft 44 is shown in more detail in FIGS. 16 and 17. At its one end it has a body 64 in which an opening is let in. A projection 48, at the end of which a thread 59 is let in, is linked with the body 64.

The shaft 44 with its body 64 sits at one end of a sleeve-shaped guide element 40. Two bearings 49 and 50 are arranged around the projection 48 of the shaft 44 and are held using Seeger rings 51 and 52. The projection 48 as well as the bearing 50 are secured by a retaining component 53 secured using a screw to the projection 48.

The clamps 41 and 42 are secured to the guide element 40 in the manner already described.

A connecting link element 45 is let into the opening 63 of the shaft 44 and is shown in more detail in FIGS. 18 and 19. The connecting link element 45 has an opening 62, in which the projection 58 of the ceiling flange 43 engages. Furthermore, two diametrically arranged threads 61 for receiving the set screws 46 are provided at the connecting link element 45 (cf. Also FIG. 20). Two diametrically arranged threads 47 are also provided perpendicular to this and in which the screws 56 engage (cf. FIG. 13).

In the following the assembly of the setting system 39 as well as its method of operation will be explained in more detail. First, the ceiling flange 43 is secured to the ceiling using the screws pushed through the opening 57. Then the connecting link element 45 on projection 48 is arranged on the projection 58 of the ceiling flange 43, namely by using the setscrews 46. Then the shaft 44 is arranged on the connecting link element 45, the screws 56, which engage in the thread 47 of the connecting link element 45, being inserted in the openings 60 of the shaft 44. Then the guide element 40 is arranged together with the bearings on the projection 48 of the shaft 44 and secured using the retaining component 53 which is accessible through a cover 54.

The upper edge of the door (not shown) can now be set relative to the floor-concealed door closer 1, by screwing the screws 56 into the respective thread 47 or out of the respective thread 47. In doing so, the connecting link element 45 moves relative to the body 64 of the shaft 44 respectively to the guide element 40. In this manner a setting option is provided.

### LIST OF REFERENCE NUMERALS

1 Floor-concealed door closer

2 Housing

3 Coupling flange

4 Borehole

5 Housing cover

6 Spring supporting member

7 Shaft

8 Spring retaining washer

9 Pressure spring

10 Spring retaining washer

11 Bearing

12 Setting ring

13 Loading washer

14 Thread on housing

15 Bearing

16 Disk

17 Bearing

18 curved surface

19 Roller

20 Roller

21 Roller pin

22 Roller pin

23 Opening

24 Opening

25 curved opening surface

26 Roller

27 Roller

28 Roller pin

29 Clamp

30 Clamp

31 Fastening

32 Clamping joint

33 Clamping joint

34 Fixing means

35 Fixing means

36 Tapped hole

37 Receptacle

38 Receptacle

39 Setting system

40 Guide element

41 Clamp

42 Clamp

43 Ceiling flange

44 Shaft

45 Connecting link element

46 Set screw

47 Thread

48 Projection

49 Bearing

50 Bearing

51 Seeger ring

52 Seeger ring

53 Retaining component

54 Cover

55 O ring

56 Screw

57 Opening

58 Projection

59 Thread

60 Opening

61 Thread

62 Opening

63 Opening

64 Body

What is claimed is:

1. A drive for a movable element with which the element is brought from an initial position into a second position, in particular an opening and a closing position, comprising:
a housing,
at least one spring element, which is arranged in the housing,
at least one spring supporting member, at which the spring element is supported,
at least one roller element, which is arranged at the spring supporting member, wherein the spring supporting member has at last one curved surface and the roller element is arranged at the curved surface.

2. The drive according to claim 1, wherein the spring element is supported at an initial end of the spring supporting member and at a second end of the spring supporting member the curved surface is arranged.

3. The drive according to claim 2, wherein at least one opening is arranged at the spring supporting member, which opening has a curved opening surface.

4. The drive according to claim 3, wherein at least two roller elements are provided, the one roller element being arranged at the curved surface at the second end of the spring supporting member, and the other roller element at the curved opening surface of the opening.

5. The drive according to claim 1, wherein the spring supporting member is movably arranged in the housing along an axis of the housing.

6. The drive according to claim 1, wherein a shaft is received in the housing, at which shaft the spring element is arranged, the shaft having an initial and a second end.

7. The drive according to claim 6, wherein the shaft is received in the spring supporting member and a bearing is arranged between two adjacent surfaces of the shaft and of the spring supporting member.

8. The drive according to claim 6, wherein the housing has a longitudinal axis and the shaft runs along this longitudinal axis essentially across the full length of the housing.

9. The drive according to claim 1, wherein the spring element has an initial and a second end, one end being arranged at a spring retaining washer.

10. The drive according to claim 9, wherein the spring retaining washer arranged at the initial end of the spring element is also arranged at the spring supporting member.

11. The drive according to claim 1, wherein the housing has an initial and a second end.

12. The drive according to claim 11, wherein a bearing is arranged respectively at the initial and second end of the housing.

13. The drive according to claim 12, wherein the spring retaining washer arranged at the second end of the spring element is arranged at the bearing, which is arranged at the initial end of the housing.

14. The drive according to claim 11, wherein a housing cover is arranged at the initial end of the housing.

15. The drive according to claim 11, wherein a coupling flange is arranged at the second end of the housing.

16. The drive according to claim 12, wherein the bearing is arranged at the second end of the housing between a disk and the coupling flange.

17. The drive according to claim 12, wherein a setting ring is arranged at the initial end of the housing and the bearing is arranged between the setting ring and the spring retaining washer of the second end of the spring element.

18. The drive according to claim 17, wherein the setting ring has a thread assigned to a thread at the initial end of the housing.

19. The drive according to claim 11, wherein the initial end of the shaft assigned to the initial end of the housing has a receptacle with a thread, and a loading washer is arranged between the initial end of the shaft and the housing cover.

20. The drive according to claim 1, wherein the housing has a roller pin at which the roller element is arranged.

21. The drive according to claim 1 wherein a roller pin is arranged at the level of the opening of the spring supporting member, at which roller pin the roller element is arranged.

22. The drive according to claim 21, wherein the shaft has a receptacle for the roller pin.

23. The drive according to claim 1, wherein at least one clamping fitting is provided for receiving the movable element.

24. The drive according to claim 1, comprising at least one damping element.

25. The drive according to claim 1, wherein a setting system for the movable element is assigned to the drive.

26. The drive according to claim 25, wherein the setting system comprises an eccentric arrangement.

27. The drive according to claim 25, wherein the setting system has a disk at which at least one ball is arranged, the position of which is adjustable using an adjusting element.

28. The drive according to claim 25, wherein the setting system comprises
a shaft,
a connecting link element arranged at the shaft and
a guide element arranged at the shaft, the guide element being arranged so that can move relative to the connecting link element.

29. The drive according to claim 28, wherein the connecting link element is connected using at least one setting means with the guide element.

30. The drive according to claim 29, wherein the connecting link element has at least one thread in which the setting means in the form of a screw engages.

31. The drive according to claim 25, wherein the setting system has at least one bearing.

32. The drive according to claim 1, wherein at least one of: the housing, the spring supporting member and the guide element is cylindrical in shape.

33. The drive according to claim 1, wherein at least one of: the housing, the spring supporting member and the guide element takes the form of a sleeve.

34. A door closer for closing an associated door with a drive according to claim 1.
